(19) United States
(12) Patent Application Publication
(10) Pub. No.: US 2018/0094463 A1
(43) Pub. Date: Apr. 5, 2018

(54) DOOR HANDLE ASSEMBLY WITH A MAGNETIC FIELD DETECTOR

(71) Applicant: Huf North America Automotive Parts Mfg. Corp., Milwaukee, WI (US)

(72) Inventor: James Sanborn, Hudson, MI (US)

(21) Appl. No.: 15/724,829

(22) Filed: Oct. 4, 2017

Related U.S. Application Data
(60) Provisional application No. 62/404,274, filed on Oct. 5, 2016.

(51) Int. Cl. E05B 81/76; E05B 85/10; G01D 5/14

(52) U.S. Cl. CPC E05B 81/76; G01D 5/145; E05B 85/10

(57) ABSTRACT

A door handle for a vehicle is disclosed. The door handle includes a housing, a handle, a hall sensor, a magnet and a paramagnetic or ferromagnetic material. The housing is attached to the vehicle. The handle is mounted to the housing and is movable between a home position and an actuated position relative to the housing. The hall sensor is attached to one of the housing and the handle. The magnet is attached to the other one of the housing and the handle. The magnet is surrounded by a magnetic field. The paramagnetic or ferromagnetic material is disposed between the handle and the housing and operable to direct the magnetic field from the magnet toward the hall sensor.

### CROSS REFERENCE TO RELATED APPLICATION

This application claims priority to U.S. Provisional Application Ser. No. 62/404,274, filed Oct. 5, 2016, the contents of which are incorporated by reference in their entirety.

### FIELD

The present disclosure relates generally to a vehicle door handle assembly that includes a magnetic field detector such as a Hall Effect sensor.

### BACKGROUND

This section provides background information related to the present disclosure and is not necessarily prior art.

Generally, a Hall Effect sensor or a magnetic field detector is a transducer that varies its output voltage in response to a magnetic field. Hall Effect sensors have various applications that include proximity switching, positioning, speed detection, and current sensing applications, among others. In some examples, the Hall Effect sensor operates as an analogue transducer; while in other examples, the Hall Effect sensor operates in a digital mode. While operating as an analogue transducer, the Hall Effect sensor returns a voltage. As such, the distance from the Hall plate (also referred to as the magnet) of the Hall Effect sensor may be determined. While operating in a digital mode, the Hall Effect sensor acts in an On/Off mode. As such, the Hall Effect sensor may be identified as a switch.

FIG. 1A illustrates a Hall Effect Sensor activated by an external magnetic field. As shown, the magnetic field includes flux density and polarity (e.g., North Pole (N) and South Pole (S)). The output signal from the Hall Effect sensor is the function of magnetic flux density around the device. In some examples, the magnetic flux density around the sensor exceeds a certain pre-set threshold. In this case, the sensor detects the magnetic flux density and generates an output voltage called the Hall Voltage V_{H}.

With continued reference to FIG. 1A, the Hall Effect sensor includes a thin piece of semiconductor material also known as the Hall element. For example, the Hall element may be a thin piece of rectangular p-type semiconductor material, passing a continuous current though itself. When the sensor is placed within a magnetic field, the magnetic flux lines exert a force on the semiconductor. As such, the magnetic flux lines deflect the charge carriers, electrons and holes, to either side of the semiconductor slab. The movement of the electrons and holes results in a potential difference between the two sides of the semiconductor slab. In some examples, the magnetic flux lines are perpendicular to the flow of current and are of correct polarity (i.e., generally the south pole, as shown) to generate a potential difference across the sensor device.

In some examples, and referring to FIG. 1B, the Hall Effect sensor 2 is positioned within a door handle of a vehicle. The external magnet 6 is positioned at a distance (d) from the Hall Effect sensor 2, allowing the Hall Effect sensor 2 to be within the magnetic field 8 of the magnet 2 in a first position, and to be outside the magnetic field 8 in a second position. As such, the Hall Effect sensor may be used to determine an open or closed position of the door handle of the vehicle, which may result in locking or unlocking of the vehicle. As shown in the graph of FIG. 1C, as the position and/distance between the Hall Effect sensor 2 and the external magnet 6 changes (i.e., increases), the Hall Effect sensor 2 may be moving to an area outside the magnetic field 8 of the external magnet 6. As such, when designing a door handle of a vehicle that includes a Hall Effect sensor 2, the external magnet 6 associated with the Hall Effect sensor 2 has to be placed within a distance (d) from the Hall Effect sensor 2 that falls within the magnetic field 8 of the external magnet 6.

### SUMMARY

This section provides a general summary of the disclosure, and is not a comprehensive disclosure of its full scope or all of its features.

According to one aspect, the present disclosure provides a door handle for a vehicle. The door handle includes a housing, a handle, a hall sensor, a magnet and a paramagnetic or ferromagnetic material. The housing is attached to the vehicle. The handle is mounted to the housing and is movable between a home position and an actuated position relative to the housing. The hall sensor is attached to one of the housing and the handle. The magnet is attached to the other one of the housing and the handle. The magnet is surrounded by a magnetic field. The paramagnetic or ferromagnetic material is disposed between the handle and the housing and operable to direct the magnetic field from the magnet toward the hall sensor.

Implementations of the disclosure may include one or more of the following optional features. In some implementations, the hall sensor is disposed on a printed circuit board. The hall sensor may be operable to detect a change in a magnetic field between the handle and the housing. The hall sensor may be separate from a printed circuit board disposed within the handle.

In some examples, the housing includes a handle cap. The magnet may be attached to the handle cap. The paramagnetic or ferromagnetic material may have a frustoconical shape having a first end defining a first diameter and a second end defining a second diameter greater than the first diameter. The first end may be positioned adjacent the hall sensor. The paramagnetic or ferromagnetic material may be operable to increase a distance between the hall sensor and the magnet. The hall sensor may be outside the magnetic field of the magnet in the actuated position. In some implementations, the hall sensor is a Hall Effect sensor.

Another aspect of the disclosure provides a sensor system. The sensor system includes a base, a first housing portion, a second housing portion, a sensor, a magnet, and a magnetic field extender. The first housing portion is attached to the base. The second housing portion is mounted to the base and is movable between a home position and an actuated position relative to the first housing. The sensor is attached to one of the first housing and the second housing, and is configured to detect a change in magnetic field. The magnet is attached to the other one of the first housing and the second housing. The magnet is surrounded by a magnetic field. The magnetic field extender is disposed between the first and second housing and operable to direct the magnetic field from the magnet toward the sensor.

This aspect may include one or more of the following optional features. In some implementations, the magnetic field extender includes a paramagnetic or ferromagnetic material. The magnetic field extender may have a frustoconical shape having a first end defining a first diameter and a second end defining a second diameter greater than the first diameter. The first end may be positioned adjacent the sensor. The magnetic field extender may be operable to increase a distance between the sensor and the magnet.

In some examples, the sensor is disposed on a printed circuit board. The sensor may be operable to detect a change in the magnetic field between the first and second housing. The sensor may also be separate from a printed circuit board. The sensor may be outside the magnetic field of the magnet in the actuated position. In some implementations, the sensor is within the magnetic field of the magnet in the home position. Additionally or alternatively, the sensor may be outside the magnetic field of the magnet in the actuated position. The sensor may be a Hall Effect sensor.

Further areas of applicability will become apparent from the description provided herein. The description and specific examples in this summary are intended for purposes of illustration only and are not intended to limit the scope of the present disclosure.

### DESCRIPTION OF DRAWINGS

FIG. 1A is perspective view of a prior art Hall Effect sensor with an external magnet;

FIG. 1B is another perspective view of the prior art Hall Effect sensor with the external magnet of FIG. 1A;

FIG. 1C is a graph displaying the relationship between an angle of a door handle with respect to a vehicle body and a magnetic field generated by the external magnet of FIG. 1A;

FIG. 2 is a perspective view of an exemplary Hall Effect sensor with an external magnet and a magnetic field extender in accordance with the principles of the present disclosure;

FIG. 3A is a perspective view of an exemplary door handle including the exemplary Hall Effect sensor with the external magnet and the magnetic field extender of FIG. 2;

FIG. 3B is an exploded view of the exemplary door handle of FIG. 3A;

FIG. 4A is a side view of the exemplary door handle of FIG. 3A;

FIG. 4B is a cross-sectional view of the door handle of FIG. 3A taken along Line 4B-4B of FIG. 4A;

FIG. 5A is a top view of the exemplary door handle of FIG. 3A;

FIG. 5B is a cross-sectional view of the door handle of FIG. 3A taken along Line 5B-5B of FIG. 5A; and

FIG. 6 is graph displaying the relationship between an angle of a door handle with respect to a vehicle body and a magnetic field generated by the external magnet of FIG. 2 that is channeled towards the Hall Effect sensor by the magnetic field extender of FIG. 2.

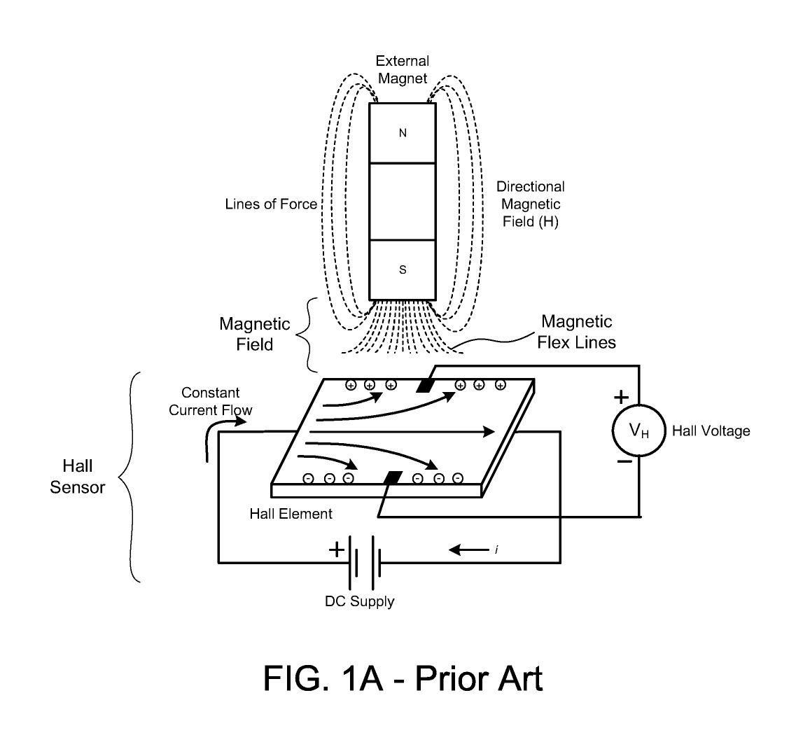

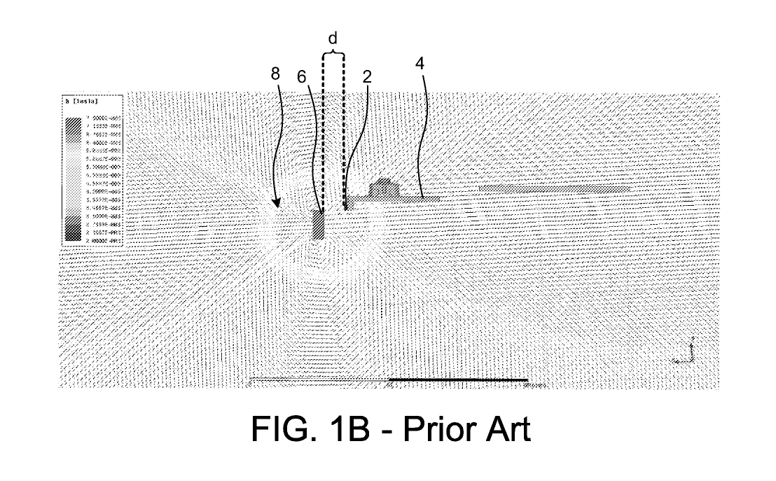

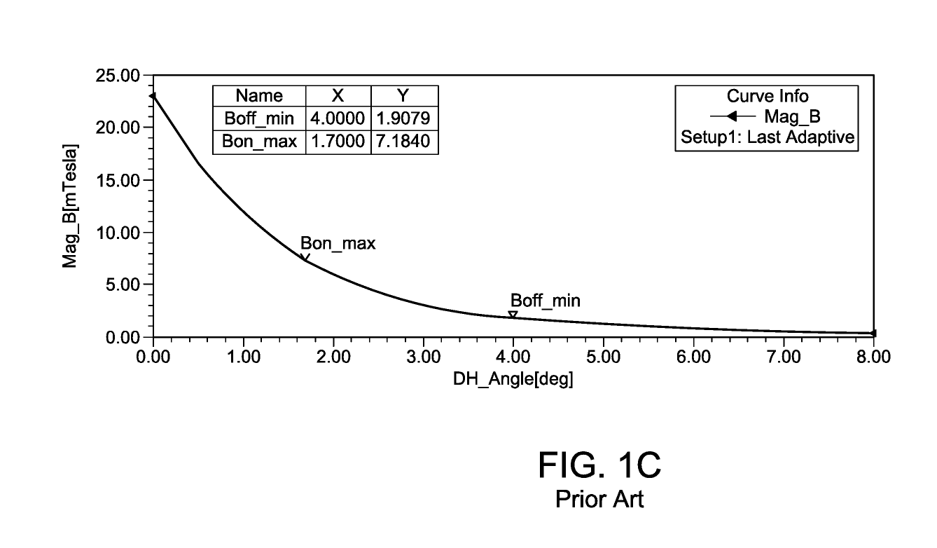

Like reference symbols in the various drawings indicate like elements.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth, such as examples of specific components, devices, and methods, to provide a thorough understanding of configurations of the present disclosure. It will be apparent to those of ordinary skill in the art that specific details need not be employed that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as, “first,” “second,” and other numerical terms do not imply a sequence or order unless clearly indicated by the context. Thus, a first element, component, region, layer or section discussed below could be termed a second element, component, region, layer or section without departing from the teachings of the example configurations.

As previously described, when designing a door handle of a vehicle that includes a Hall Effect sensor 2, careful attention should be made to the placement of the Hall Effect sensor 2 with respect to the external magnet 6. Therefore, it is desirable to design a door handle having a Hall Effect sensor that overcomes the distance limitation between the Hall Effect sensor and the external magnet. In so doing, the position of the Hall Effect sensor would no longer be tied to and limited by the position of the external magnet, which results in increased design flexibility of the door handle.

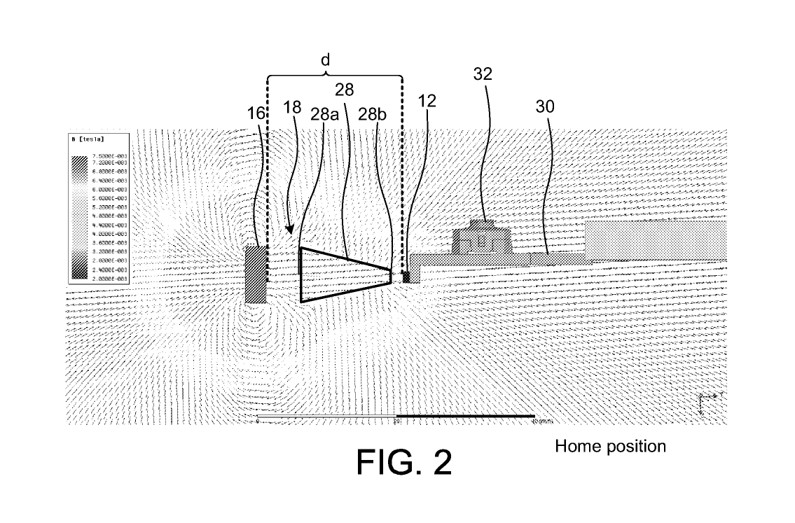

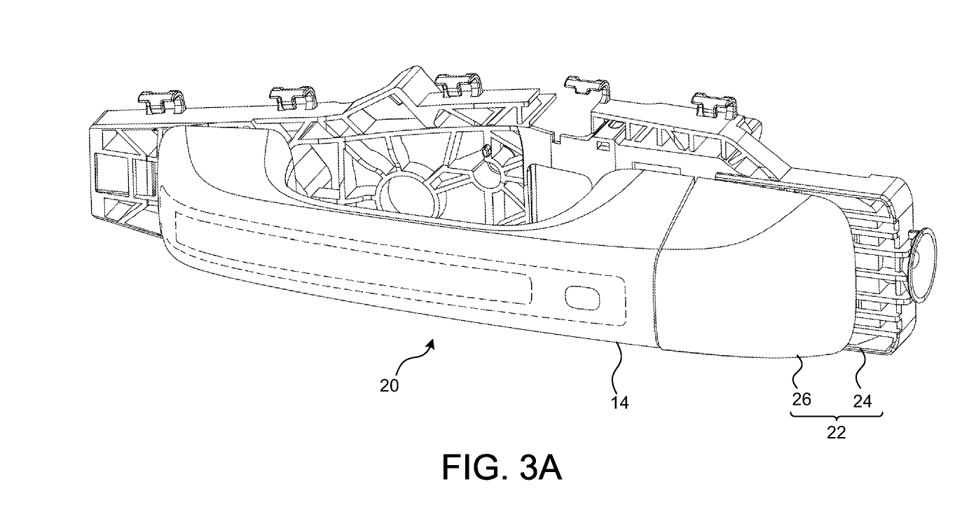

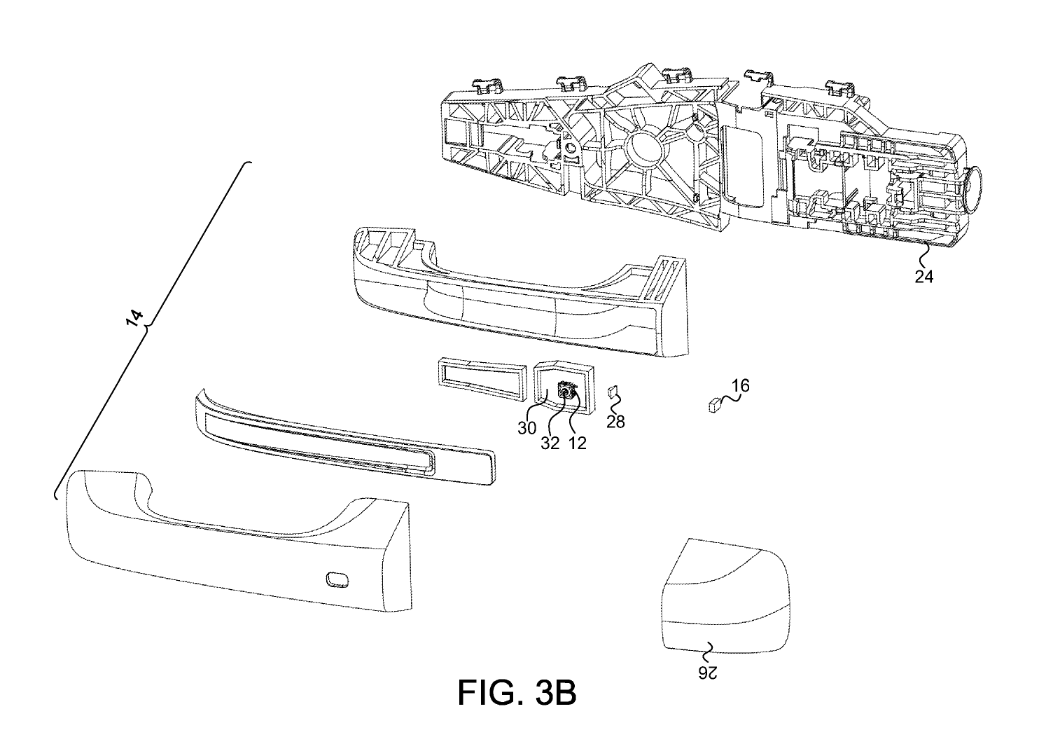

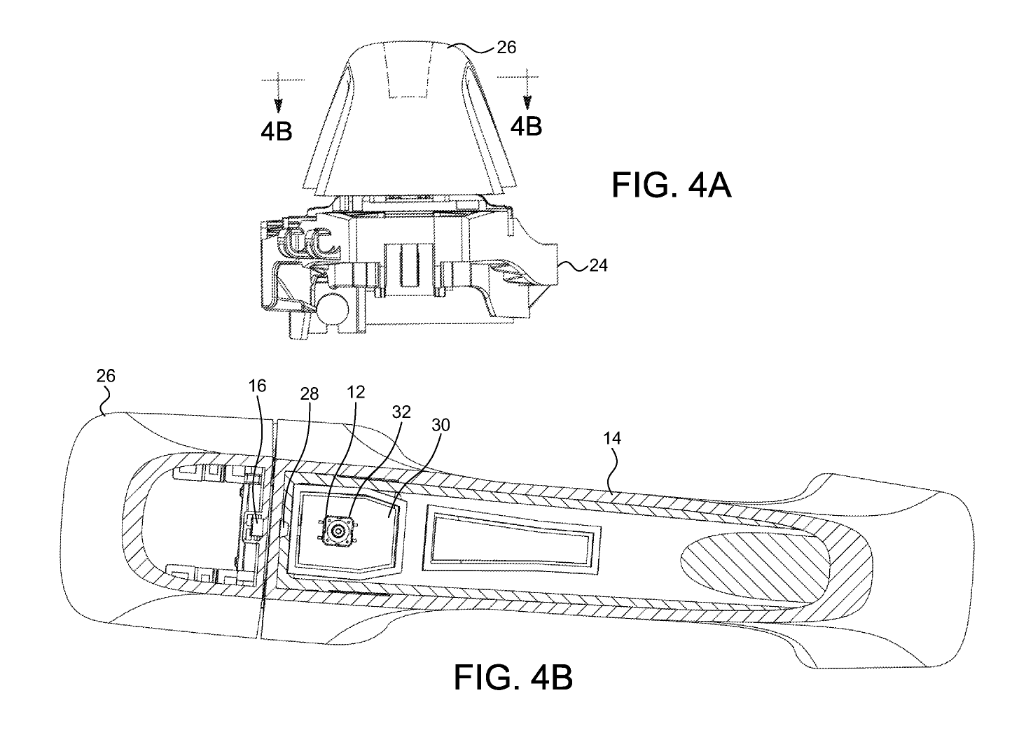

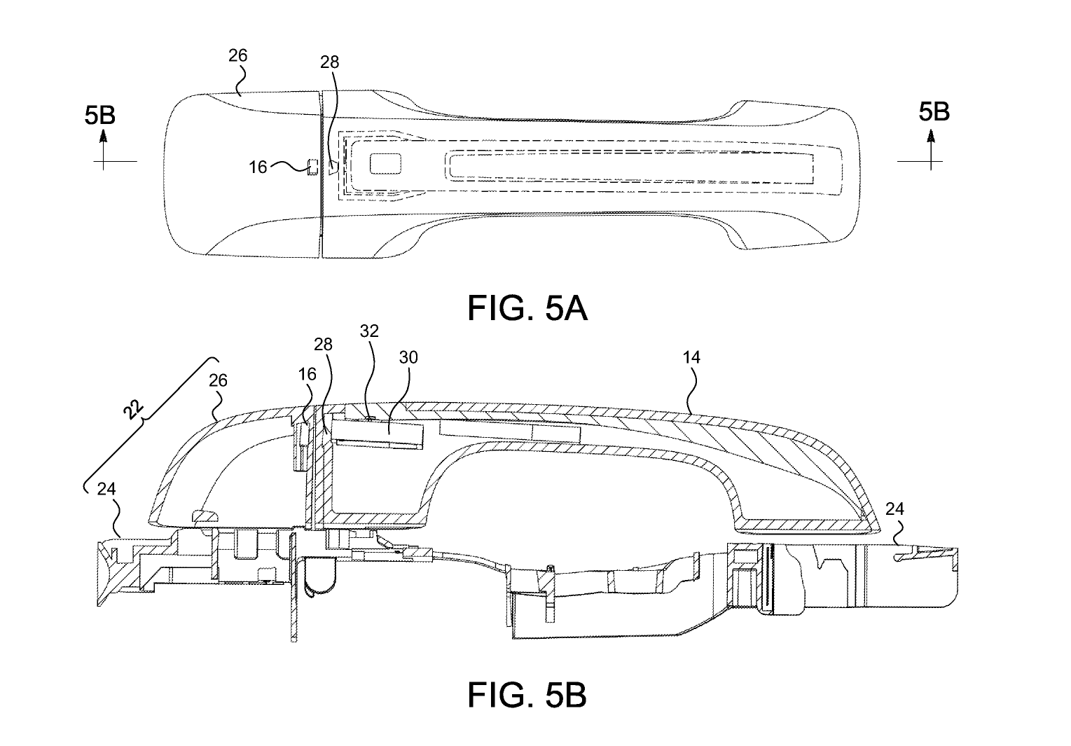

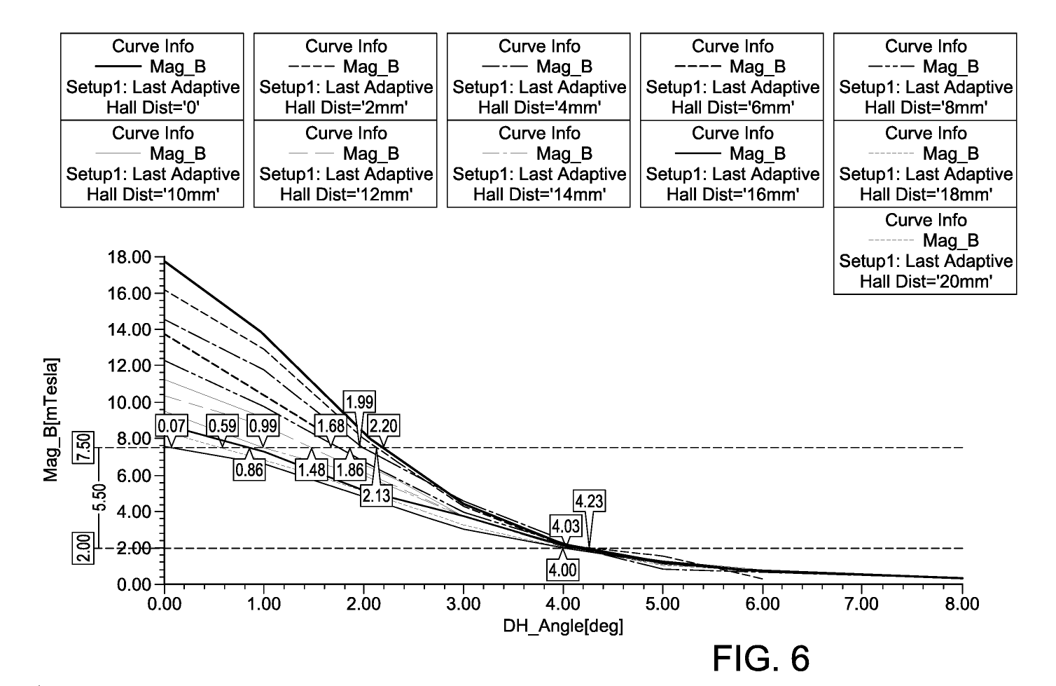

As shown in FIGS. 2-8, in some examples, a door handle 20 for a vehicle (not shown) includes a housing 22 attached to the vehicle. The housing 22 may include a base attached to the vehicle and a handle cap 26 attached to the base 24. A handle 14 may be mounted to the housing and movable between a home position and an actuated position relative to the housing 22. For example, when in the home position, the handle 14 and the handle cap 26 may be substantially flush with respect to one another when viewed by a user. While in the actuated position, the handle 14 moves with respect to the handle cap 26 such that the handle 14 is raised from the handle cap 26 resulting in an elevation distance between the handle 14 and the handle cap 24.

A Hall Effect sensor 12 may be attached to one of the housing 22 (e.g., the handle cap 26) and the handle 14, while a magnet 16 is attached to the other one of the housing 22 and the handle 14. In some examples, the Hall Effect sensor 12 is positioned on a printed circuit board (PCB) attached to the other one of the housing 22 and the handle 14. The PCB 30 may include a button 32 operable to receive an indication from a vehicle user to lock or unlock the vehicle. In some examples, the indication is a touch or a push indication. The PCB 30 may include other sensors and components. Therefore, the location of the Hall Effect sensor 12 and, thus, the PCB 30 including all of its components is not limited by the position of the magnet 16. Accordingly, the door handle 20 allows for a more flexible design of the door handle 20. As such, the button 32 positioned on the PCB 30 is also not limited to its location adjacent the magnet 16, which provides flexibility in positioning the button 32 within the handle 14 or the housing 22.

In some examples (not shown), the Hall Effect sensor 12 may be positioned on a PCB separate from the PCB supporting the button 32. As such, the location of the PCB supporting the button 32 is independent of the location of the PCB supporting the Hall Effect sensor 12. In this case, there is more flexibility in the design of the door handle 20, as both the button 32 and the hall sensor 12 are not restricted by the position and magnetic field 18 of the magnet 16.

The Hall Effect sensor 12 may be in digital mode and may provide an indication when the handle 14 is in the home position or the actuated position relative to the housing 22. For example, when the handle 14 is in the home position, the Hall Effect sensor 12 is within the magnetic field 18 of the magnet 16. As such, the Hall Effect sensor 12 may be ON. However, when the handle 14 is in the actuated position relative to the housing 22, the Hall Effect sensor 12 is no longer within the magnetic field 18 of the magnet and the Hall Effect may be OFF.

The door handle 20 includes the external magnet 16 attached to the other of the housing 22 (e.g., the handle cap 26) and the handle 14. The magnet 16 is surrounded by the magnetic field 18. A magnetic field extender 28 is disposed between the handle 14 and the handle cap 26. The magnetic field extender 28 directs and focuses the magnetic field 18 from the magnet 16 towards the hall sensor 12. In some examples, the magnetic field extender 28 includes a paramagnetic or ferromagnetic material. The magnetic field extender 28 may have a frustoconical shape having a first end 20a defining a first diameter and a second end 28b defining a second diameter greater than the first diameter, whereby the first end is positioned adjacent the hall sensor. In other examples, the magnetic field extender 28 may have a truncated square pyramid shape where the first end 28a has a square shape having a smaller area than a square shape of the second end 28b. The magnetic field extender 28 may have any other shape that extends the magnetic field 18 of the magnet 16 allowing it to reach the Hall Effect sensor 12. As such, the distance (d) between the magnet 16 and the Hall Effect sensor 12 may be increased relative to a prior art configuration, thereby allowing more flexibility in designing and positioning the components of the door handle 20 relative to one another.

Although the above is described with respect to a door handle, the same implementation may be applied to a sensor system 20 having a base 24, a first housing 26 attached to the base 24, and a second housing 14 mounted to the base 24 and movable between a home position and an actuated position relative to the first housing 26. For example, the foregoing system may be used in conjunction with a vehicle door and/or a tailgate to determine a position of the door and/or tailgate relative to a vehicle body (i.e., open or closed).

In such a system, the sensor system 20 may include a sensor 12, such as a Hall Effect sensor or any other sensor operable to detect a change in magnetic field 18. The sensor 12 is attached to one of the first housing 26 and the second housing 14 associated with one of the vehicle door/tailgate and the vehicle body. The sensor system 20 includes a magnet 16 attached to the other one of the first housing 26 and the second housing 14 associated with the other of the vehicle door/tailgate and the vehicle body. The magnet 16 is surrounded by a magnetic field 18. The sensor system 20 may also include a magnetic field extender 28, disposed between the first housing 26 and the second housing 14 and operable to direct the magnetic field 18 from the magnet 16 towards the sensor 12, extending the reach of the magnetic field and allowing the sensor 12 to be placed at a distance outside the magnetic field 18 of the magnet 16.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A door handle for a vehicle, the door handle comprising:
a housing attached to the vehicle;
a handle mounted to the housing and movable between a home position and an actuated position relative to the housing;
a hall sensor attached to one of the housing and the handle;
a magnet attached to the other one of the housing and the handle, the magnet being surrounded by a magnetic field; and
a paramagnetic or ferromagnetic material disposed between the handle and the housing and operable to direct the magnetic field from the magnet toward the hall sensor.

2. The door handle of claim 1, wherein the hall sensor is disposed on a printed circuit board.

3. The door handle of claim 1, wherein the hall sensor is operable to detect a change in a magnetic field between the handle and the housing.

4. The door handle of claim 1, wherein the hall sensor is separate from a printed circuit board disposed within the handle.

5. The door handle of claim 1, wherein the housing comprises a handle cap, the magnet being attached to the handle cap.

6. The door handle of claim 1, wherein the paramagnetic or ferromagnetic material has a frustoconical shape having a first end defining a first diameter and a second end defining a second diameter greater than the first diameter, the first end positioned adjacent the hall sensor.

7. The door handle of claim 6, wherein the paramagnetic or ferromagnetic material is operable to increase an operating distance between the hall sensor and the magnet.

8. The door handle of claim 7, wherein the hall sensor is outside the magnetic field of the magnet in the actuated position.

9. The door handle of claim 1, wherein the hall sensor is a Hall Effect sensor.

10. A sensor system comprising:
a base;
a first housing attached to the base;
a second housing mounted to the base and movable between a home position and an actuated position relative to the first housing;
a sensor attached to one of the first housing and the second housing and configured to detect a change in magnetic field;
a magnet attached to the other one of the first housing and the second housing, the magnet being surrounded by a magnetic field; and
a magnetic field extender disposed between the first housing and the second housing and operable to direct the magnetic field from the magnet toward the sensor.

11. The sensor system of claim 10, wherein the magnetic field extender comprises a paramagnetic or ferromagnetic material.

12. The sensor system of claim 10, wherein the magnetic field extender has a frustoconical shape having a first end defining a first diameter and a second end defining a second diameter greater than the first diameter, the first end positioned adjacent the sensor.

13. The sensor system of claim 10, wherein the magnetic field extender is operable to increase an operating distance between the sensor and the magnet.

14. The sensor system of claim 10, wherein the sensor is disposed on a printed circuit board.

15. The sensor system of claim 10, wherein the sensor is operable to detect a change in the magnetic field between the first housing and the second housing.

16. The sensor system of claim 10, wherein the sensor is separate from a printed circuit board.

17. The sensor system of claim 10, wherein the sensor is outside the magnetic field of the magnet in the actuated position.

18. The sensor system of claim 10, wherein the sensor is within the magnetic field of the magnet in the home position.

19. The sensor system of claim 10, wherein the sensor is outside the magnetic field of the magnet in the actuated position.

20. The sensor system of claim 10, wherein the sensor is a Hall Effect sensor.
